(19) United States
(12) Patent Application Publication
(10) Pub. No.: US 2026/0103939 A1
(43) Pub. Date: Apr. 16, 2026

(54) DOOR OPEN-CLOSE DEVICE FOR VEHICLE

(71) Applicants: Hyundai Motor Company, Seoul (KR); Kia Corporation, Seoul (KR); KWANGJIN CO., LTD., Asan-si (KR)

(72) Inventors: Jaeseung LEE, Hwaseong-si (KR); Jin-Su JANG, Asan-Si (KR); Tae-Yong JEON, Pyeongtaek-Si (KR); Pil-Seong JEON, Asan-Si (KR); Jun-Yeong BAE, Asan-Si (KR)

(73) Assignees: Hyundai Motor Company, Seoul (KR); Kia Corporation, Seoul (KR); KWANGJIN CO., LTD., Asan-si (KR)

(21) Appl. No.: 19/236,126

(22) Filed: Jun. 12, 2025

(30) Foreign Application Priority Data
Oct. 16, 2024 (KR) 10-2024-0141353

(51) Int. Cl. E05F 15/63

(52) U.S. Cl. CPC E05F 15/63; E05F 2015/631; E05Y 2201/434; E05Y 2400/55; E05Y 2600/46; E05Y 2900/531

(57) ABSTRACT

A door open-close device for a vehicle configured to open or close a door opening portion by sliding and popping up a door disposed in a vehicle body includes a main arm motor fixedly disposed on a side of the vehicle body and configured to provide a driving power to operate the door, a main arm including a first end portion engaged to the main arm motor and a second end portion hingedly coupled to a side of the door and configured to transmit a rotation force to the door by receiving the driving power from the main arm motor, and a variable sub-arm including a first end portion hingedly coupled to the side of the vehicle body, a second end portion hingedly coupled to the side of the door, and when the door is opened or closed, disposed to change a length thereof due to engagement of a gear by driving a motor disposed in one portion.

### CROSS-REFERENCE TO RELATED APPLICATION

The present application claims priority to Korean Patent Application No. 10-2024-0141353 filed with the Korean Intellectual Property Office on Oct. 16, 2024, the entire contents of which is incorporated herein for all purposes by this reference.

### BACKGROUND OF THE PRESENT DISCLOSURE

### Field of the Present Disclosure

The present disclosure relates to a door open-close device for a vehicle, and more particularly, to a bi-directional door open-close device for a vehicle configured to open or close a door opening portion of a vehicle body by sliding and popping up a door of the vehicle in both front and rear directions, in the vehicle without a B-pillar.

### Description of Related Art

In general, doors for a vehicle are doors that separate the interior and exterior of the vehicle, and serve an important function of protecting passengers safely by blocking external noise, rain, dust, and wind, etc and absorbing an impact along with a side structure in case of a side collision.

There are various types of doors for the vehicle, including doors for special purposes, but hinged swing doors are most often applied to passenger vehicles.

Usually, a swing door refers to a door that opens to the outside of a vehicle body around a hinge shaft installed through a hinge bracket between the vehicle body and the swing door, and has the advantage of being easy to open or close, and easy to maintain and repair due to a simple structure.

On the other hand, a counter-swing door that has a high sense of openness when a door is opened, and is advantageous for passengers to get on or off is applied to some vehicles. The counter-swing door is opened and closed by use of the rotation of an arm connected to the vehicle body and the door.

However, a fixing link swing type door among such counter-swing doors has the advantage of having a large amount of door opening and closing, but as shown in FIG. 1, when a door of a vehicle including a front door 2 connected to a vehicle body 1 by a front door arm 4 is opened, and when door arms 4 and 5 are rotated, due to lengths of the door arms 4 and 5, an amount of protrusion of the door to the outside of the vehicle is excessive, and there is a risk of colliding with an external obstacle. To this end, it is necessary to perform operations such as stop/reverse after collision.

In addition, as shown in FIG. 2, the order of opening and closing of front and rear doors is fixed, a manual operation is limited in case of emergency, and there is a possibility of collision between the front and rear doors during the manual operation. In addition, there are problems of sealing damage and jamming due to fixing the order of operations of the door.

### BRIEF SUMMARY

The present disclosure attempts to provide a door open-close device for a vehicle configured for improving operability, performance, and stability by applying a link of a variable length to a door, in a counter sliding door structure of the vehicle without a B-pillar.

A door open-close device for a vehicle configured to open or close a door opening portion by sliding and popping up a door disposed in a vehicle body according to an exemplary embodiment of the present disclosure includes a main arm motor fixedly disposed on a side of the vehicle body and configured to provide a driving power to operate the door, a main arm including a first end portion engaged to the main arm motor and a second end portion hingedly coupled to a side of the door and configured to transmit a rotation force to the door by receiving the driving power from the main arm motor, and a variable sub-arm including a first end portion hingedly coupled to the side of the vehicle body, a second end portion hingedly coupled to the side of the door, and when the door is opened or closed, disposed to change a length thereof due to engagement of a gear by driving a motor disposed in one portion.

A main arm gear may be disposed in one end portion of the main arm, and engaged with a main arm motor gear disposed on a rotation shaft of the main arm motor, so that the main arm is hingedly rotated when the main arm motor is driven.

The main arm may be disposed in a curved shape toward an interior of the vehicle body.

The variable sub-arm may include a fixing sub-arm including one end portion hingedly coupled to the side of the vehicle body and a hollow disposed therein, and a slide sub-arm slidably engaged to the fixing sub-arm and movable in a longitudinal direction of the fixing sub-arm so that one end portion thereof is moved relative to the fixing sub-arm, and the other end portion thereof is hingedly coupled to the side of the door.

The fixing sub-arm may be disposed in a hollow shape extending in the longitudinal direction, and the slide sub-arm may operate to be inserted into and withdrawn from the hollow of the fixing sub-arm.

The slide sub-arm may be slid based on the driving of the variable arm motor disposed on one side of the fixing sub-arm and is moved relative to the fixing sub-arm.

An internal opening may be disposed in the slide sub-arm in a longitudinal direction of the slide sub-arm, and a rack gear may be disposed inside the internal opening.

A pinion gear may be disposed on a rotation shaft of the variable arm motor, engaged with the rack gear of the slide sub-arm, and rotated when the variable arm motor is driven, so that the slide sub-arm is slid and moved in the longitudinal direction of the fixing sub-arm and a length of the variable sub-arm is expanded or contracted.

A base plate in which the main arm motor is fixedly disposed and to which one end portion of the main arm is hingedly coupled, and one end portion of the variable sub-arm is hingedly coupled, may be disposed on the side of the vehicle body.

The variable arm motor may be fixed on the fixing sub-arm by a variable arm motor mounting bracket.

A door bracket to which the other end portion of the main arm and the other end portion of the variable sub-arm may be hingedly coupled and connecting the main arm and the variable sub-arm to the door may be disposed inside the door.

A door obstacle detection sensor configured to detect a proximity obstacle located outside the door may be disposed on an external surface of the door.

A vehicle body obstacle detection sensor configured to detect a proximity obstacle located outside the vehicle body may be disposed on an external surface of the vehicle body.

The door obstacle detection sensor may be disposed in front and rear of the door in the longitudinal direction of the vehicle body, and the vehicle body obstacle detection sensor may be disposed outside the door opening portion.

Each of the door obstacle detection sensor and the vehicle body obstacle detection sensor may be disposed as an ultrasonic sensor, and have a detection range of an angle of about 135° to about 145° toward the outside of the vehicle body.

When the door starts to be opened, the main arm motor may be driven to rotate one end portion of the main arm, and the variable arm motor may be driven to shorten a length of the variable sub-arm.

During the opening of the door, when an obstacle is detected by the door obstacle detection sensor or the vehicle body obstacle detection sensor, driving of the main arm motor may be stopped, and the variable arm motor may be driven to extend a length of the variable sub-arm so that a position of the door is changed to an obstacle avoidance position.

After the position of the door is changed to the obstacle avoidance position, the main arm motor may be driven again to rotate one end portion of the main arm, and the variable arm motor may be driven to shorten the length of the variable sub-arm again after driving thereof is temporarily stopped, and driven to extend the length of the variable sub-arm again when an amount of protrusion of the door is maximum.

According to an exemplary embodiment of the present disclosure, the variable door arm structure is applied in the counter sliding door structure of the vehicle without a B-pillar, and thus, the door rotation radius may be minimized, minimizing the amount of protrusion toward the outside of the vehicle body of the door when the door is opened.

Furthermore, an interference avoidance operation between the front and rear doors is possible, which enables the door open-close operation regardless of the order of the front and rear doors, and sealing damage and jamming according to the order of door operations may be prevented.

Furthermore, a center rail structure is deleted, and thus, the door opening width may be maximized, and cost reduction, assembly, and maintainability may be improved due to the simplification of the structure.

Furthermore, the interaction between the variable door arm and the obstacle detection sensor may detect an external obstacle when the door operates and prevent the door from colliding with the obstacle.

### BRIEF DESCRIPTION OF THE DRAWINGS

FIG. 1 is a diagram schematically illustrating an opening or closing state of a fixing link swing type door of the related art.

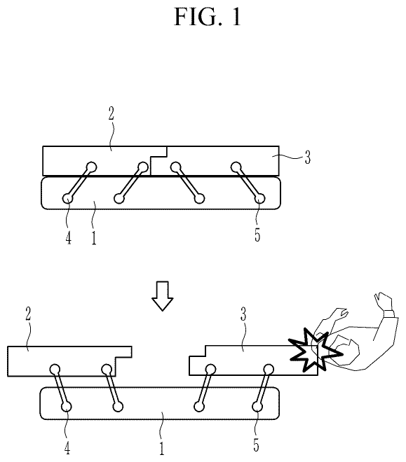

FIG. 2 is a diagram schematically illustrating an opening operation process of the fixing link swing type door of the related art.

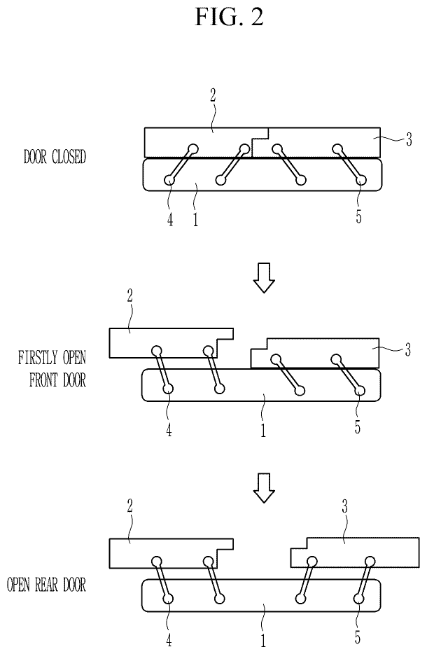

FIG. 3 is a diagram schematically illustrating a state in which a door open-close device for a vehicle according to an exemplary embodiment of the present disclosure is applied to the vehicle.

FIG. 4 is a diagram schematically illustrating a state in which the door open-close device for the vehicle according to an exemplary embodiment of the present disclosure is disposed on a door.

FIG. 5 is a diagram illustrating a main arm and a main arm motor of the door open-close device for the vehicle according to an exemplary embodiment of the present disclosure.

FIG. 6 is an exploded perspective view of the door open-close device for the vehicle according to an exemplary embodiment of the present disclosure.

FIG. 7 is a diagram schematically illustrating a door closing state of the door open-close device for the vehicle according to an exemplary embodiment of the present disclosure viewed from above.

FIG. 8 is a diagram schematically illustrating a door opening start state of the door open-close device for the vehicle according to an exemplary embodiment of the present disclosure viewed from above.

FIG. 9 is a diagram schematically illustrating a state, viewed from above, in which a door is in a general movement or an obstacle avoidance movement due to a change in the length of a variable sub-arm after a door opening start of the door open-close device for the vehicle according to an exemplary embodiment of the present disclosure.

FIG. 10 is a diagram schematically illustrating a door opening completion state of the door open-close device for the vehicle according to an exemplary embodiment of the present disclosure viewed from above.

FIG. 11 is a perspective view schematically illustrating a variable sub-arm of the door open-close device for the vehicle according to an exemplary embodiment of the present disclosure.

FIG. 12 is a diagram schematically illustrating a connection relationship between a pinion gear of a variable arm motor and a rack gear of a slide sub-arm for expanding or contracting a length of the variable sub-arm of the door open-close device for the vehicle according to an exemplary embodiment of the present disclosure.

FIG. 13 is a diagram illustrating a connection relationship between the main arm and the variable sub-arm for adjusting a door angle and an amount of door protrusion when a door of the door open-close device for the vehicle according to an exemplary embodiment of the present disclosure is opened or closed.

FIG. 14 is a graph illustrating driving states of a main arm motor and a variable arm motor for adjusting the door angle and the amount of door protrusion of the door open-close device for the vehicle according to an exemplary embodiment of the present disclosure.

FIG. 15 is a diagram schematically illustrating a position, viewed from above, of the door of the door open-close device for the vehicle according to an exemplary embodiment of the present disclosure in a “period A” of FIG. 14.

FIG. 16 is a diagram schematically illustrating a position, viewed from above, of the door of the door open-close device for the vehicle according to an exemplary embodiment of the present disclosure in a “period B” of FIG. 14.

FIG. 17 is a diagram schematically illustrating a position, viewed from above, of the door of the door open-close device for the vehicle according to an exemplary embodiment of the present disclosure in a “period C” of FIG. 14.

FIG. 18 is a diagram schematically illustrating a region, viewed from above, where an obstacle is detected by a door obstacle detection sensor and a vehicle body obstacle detection sensor in a door closing state of the door open-close device for the vehicle according to an exemplary embodiment of the present disclosure.

FIG. 19 is a diagram schematically illustrating a region, viewed from above, where an obstacle is detected by the door obstacle detection sensor and the vehicle body obstacle detection sensor during the door opening of the door open-close device for the vehicle according to an exemplary embodiment of the present disclosure.

FIG. 20 is a diagram schematically illustrating a region, viewed from above, where an obstacle is detected by the door obstacle detection sensor and the vehicle body obstacle detection sensor when door opening of the door open-close device for the vehicle according to an exemplary embodiment of the present disclosure is completed.

### DETAILED DESCRIPTION

The present disclosure will be described more fully hereinafter with reference to the accompanying drawings, so that those skilled in the art to which the present disclosure pertains may easily implement the embodiments of the present disclosure. However, the present disclosure may be implemented in many different forms and is not limited to the embodiments described herein.

Furthermore, in various embodiments, elements having the same configuration are typically described in an embodiment by use of the same reference numerals, and in other exemplary embodiments of the present disclosure, only configurations different from an embodiment will be described.

Please be informed that the drawings are schematic and not drawn to scale. Relative dimensions and ratios of parts in the drawings are shown exaggerated or reduced in size for clarity and convenience in the drawings, and any dimensions are illustrative only and not limiting. In addition, the same reference numerals are used to denote similar features in the same structure, element or parts appearing in two or more drawings. When an element is referred to as being “on” another element, it may be directly on the other element or intervening elements may also be accompanied.

The embodiment of the present disclosure specifically represents an embodiment of the present disclosure. As a result, various modifications of diagrams are expected. Therefore, the embodiment is not limited to a specific shape of an area shown, and includes, for example, a modification of the shape by manufacturing.

Hereinafter, a door open-close device for a vehicle according to an exemplary embodiment of the present disclosure will be described in detail with reference to the accompanying drawings.

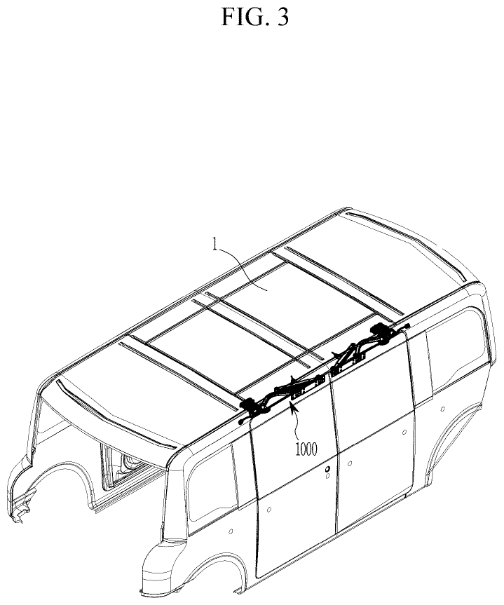

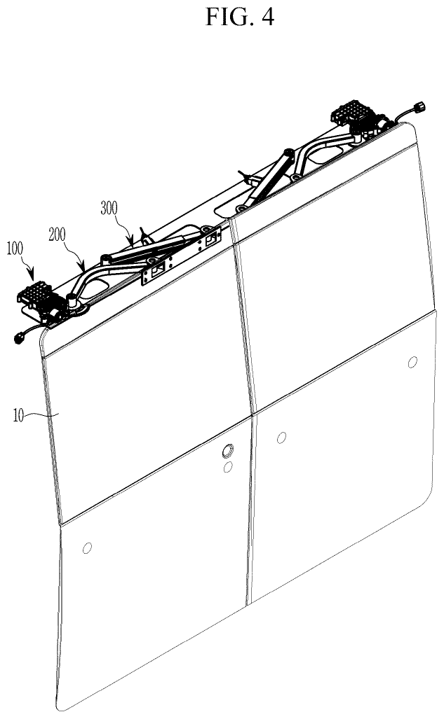

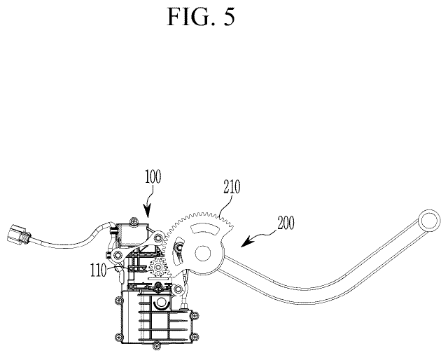

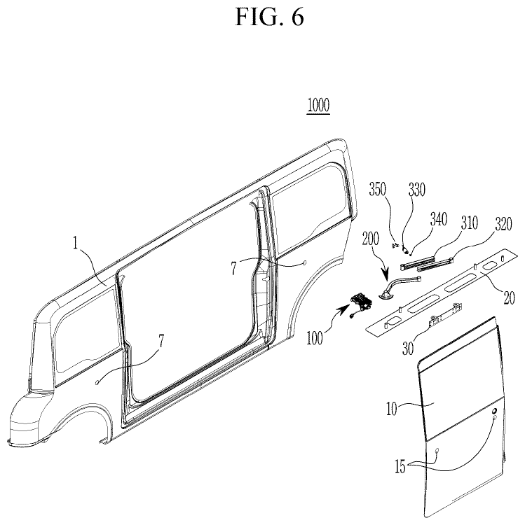

FIG. 3 is a diagram schematically illustrating a state in which a door open-close device for a vehicle according to an exemplary embodiment of the present disclosure is applied to the vehicle. FIG. 4 is a diagram schematically illustrating a state in which the door open-close device for the vehicle according to an exemplary embodiment of the present disclosure is disposed on a door. FIG. 5 is a diagram illustrating a main arm and a main arm motor of the door open-close device for the vehicle according to an exemplary embodiment of the present disclosure. FIG. 6 is an exploded perspective view of the door open-close device for the vehicle according to an exemplary embodiment of the present disclosure.

Referring to FIG. 3 and FIG. 4, a door open-close device 1000 for a vehicle according to an exemplary embodiment of the present disclosure is to open or close a door opening portion by sliding and popping up front and rear doors 10 disposed on a vehicle body 1 and is disposed in an upper portion of the door opening portion of the vehicle body 1.

The door open-close device 1000 may be disposed in a pair to face each other on the upper portion of the door opening portion corresponding to the front and rear doors 10, respectively, and may be disposed to connect the outside of the vehicle body 1 and the inside of the front and rear doors 10.

Referring to FIG. 5 and FIG. 6, the door open-close device 1000 for the vehicle according to an exemplary embodiment of the present disclosure includes a main arm motor 100, a main arm 200, and a variable sub-arm 300.

The main arm motor 100 may be fixedly disposed on the side of the vehicle body 1 and may provide a driving power to operate the door 10. The main arm motor 100 generates a driving force and transmits the driving force to the main arm 200. The main arm 200 has one end portion engaged to the main arm motor 100 and the other end portion hingedly coupled to the side of the door 10 so that the main arm 200 transmits a rotation force to the door 10 by driving the main arm motor 100.

As shown in FIG. 5, a main arm gear 210 may be disposed in one end portion of the main arm 200, and engaged with a main arm motor gear 110 disposed on a rotation shaft of the main arm motor 100, so that the main arm 200 may be hingedly rotated when the main arm motor 100 is driven.

The variable sub-arm 300 may be disposed to be parallel to the main arm 200 in a longitudinal direction of the vehicle body 1, have one end portion hingedly coupled to the side of the vehicle body 1, the other end portion hingedly coupled to the side of the door 10, and when the door 10 is opened or closed, disposed to change the length thereof due to engagement of a gear by driving a motor 330 disposed in one portion.

As shown in FIG. 6, the main arm 200 may be disposed in a curved shape toward the interior of the vehicle body 1. A base plate 20, in which the main arm motor 100 is fixedly disposed and to which one end portion of the main arm 200 is hingedly coupled, and one end portion of the variable sub-arm 300 is hingedly coupled, may be disposed on the side of the vehicle body 1.

Furthermore, a door bracket 30 to which the other end portion of the main arm 200 and the other end portion of the variable sub-arm 300 are hingedly coupled and connecting the main arm 200 and the variable sub-arm 300 to the door 10, may be disposed inside the door 10.

A door obstacle detection sensor 15 detecting a proximity obstacle located outside the door 10 may be disposed on an external surface of the door 10, and a vehicle body obstacle detection sensor 7 detecting a proximity obstacle located outside the vehicle body 1 may be disposed on an external surface of the vehicle body 1.

Meanwhile, the variable sub-arm 300 may include a fixing sub-arm 310 and a slide sub-arm 320. The fixing sub-arm 310 has one end portion hingedly coupled to the side of the vehicle body 1 and includes a hollow 305 disposed therein. One end portion of the fixing sub-arm 310 may be hingedly coupled to the base plate 20.

The slide sub-arm 320 may be slid and moved in a longitudinal direction of the fixing sub-arm 310 so that one end portion thereof is moved relative to the fixing sub-arm 310, and the other end portion thereof may be hingedly coupled to the side of the door 10. The other end portion of the slide sub-arm 320 may be hingedly coupled to the base plate 20.

The fixing sub-arm 310 may be disposed in a hollow shape extending in the longitudinal direction, and the slide sub-arm 320 may operate to be inserted into and withdrawn from the hollow of the fixing sub-arm 310.

The slide sub-arm 320 may be slid by driving the variable arm motor 330 disposed on one side of the fixing sub-arm 310 and moved relative to the fixing sub-arm 310. The variable arm motor 330 may be fixed on one side of the fixing sub-arm 310 by a variable arm motor mounting bracket 350.

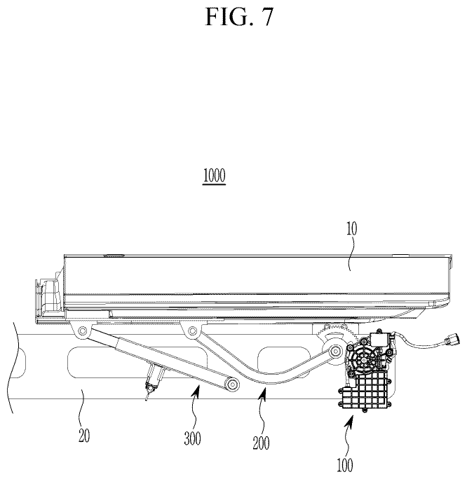

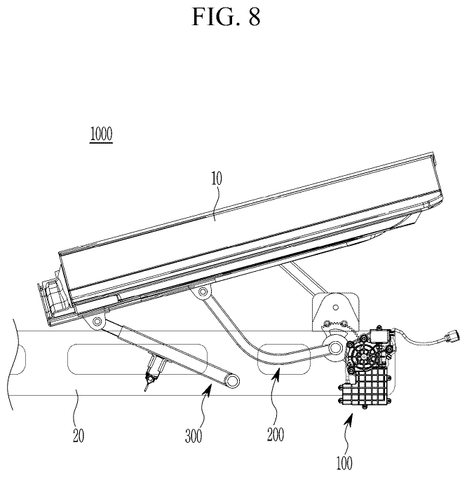

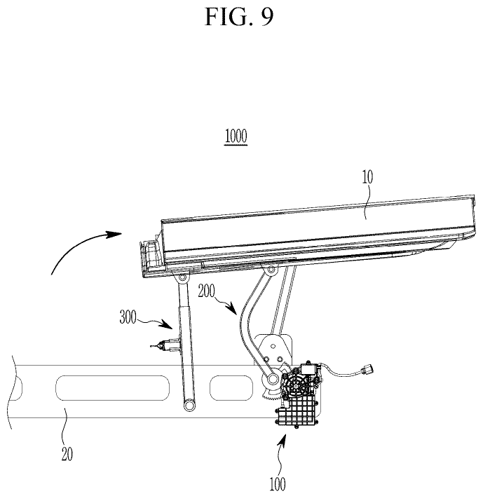

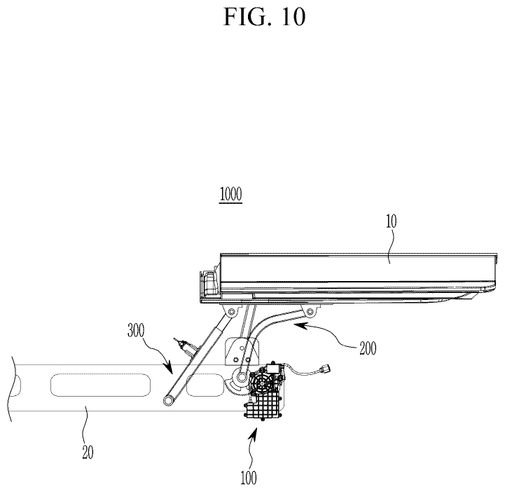

FIG. 7 is a diagram schematically illustrating a door closing state of the door open-close device for the vehicle according to an exemplary embodiment of the present disclosure viewed from above. FIG. 8 is a diagram schematically illustrating a door opening start state of the door open-close device for the vehicle according to an exemplary embodiment of the present disclosure viewed from above. FIG. 9 is a diagram schematically illustrating a state, viewed from above, in which a door is in a general movement or an obstacle avoidance movement due to a change in the length of a variable sub-arm after a door opening start of the door open-close device for the vehicle according to an exemplary embodiment of the present disclosure. FIG. 10 is a diagram schematically illustrating a door opening completion state of the door open-close device for the vehicle according to an exemplary embodiment of the present disclosure viewed from above.

Referring to FIG. 7, in a state in which the door 10 is closed, the door 10 is disposed parallel to the vehicle body 1, a central axis of the main arm gear 210 disposed in one end portion of the main arm 200 is rotatably connected to the base plate 20, and the other end portion of the main arm 200 is rotatably connected to the door bracket 30. In addition, one end portion of the variable sub-arm 300 is rotatably connected to the base plate 20, and the other end portion is rotatably connected to the door bracket 30. At this time, the main arm motor 100 and the variable arm motor 330 are not driven.

Referring to FIG. 8, in a state in which the door 10 starts to be opened, the variable arm motor 330 is driven to shorten the length of the variable sub-arm 300, and the main arm motor 100 is driven to allow the main arm 200 to turn toward the outside of the vehicle body 1. Therefore, the door 10 is disposed in an inclined form to protrude further from the side of the main arm 200 to the outside of the vehicle body 1 than from the side of the variable sub-arm 300.

Referring to FIG. 9, when an obstacle is detected adjacent to the door 10 on the side of the main arm 200 by a door obstacle detection sensor 15 or a vehicle body obstacle detection sensor 7, the driving of the main arm motor 100 is stopped, and the variable arm motor 330 starts driving. The driving of the variable arm motor 330 extends the length of the variable sub-arm 300 so that the door 10 is changed to be close to a state parallel to the vehicle body 1. The movement of the main arm 200 and the variable sub-arm 300 may be adjusted according to the position of an obstacle existing outside the door 10. That is, after the position of the obstacle is detected, an angle of the door 10 and the length of the variable sub-arm 300 may be determined to avoid the obstacle, which may be determined by adjusting an amount of rotation of the variable arm motor 330.

The angle of the door 10 and the length of the variable sub-arm 300 may be determined by and the amount of rotation of the main arm motor 100 and the variable arm motor 330 may be performed by a controller. At the instant time, the controller may be implemented as one or more processors operating by a set program, and the set program may be programmed to perform a door opening/closing process of the door open-close device for the vehicle according to an exemplary embodiment of the present disclosure.

Referring to FIG. 10, the main arm 200 is rotated by driving the main arm motor 100 until the opening of the door 10 is completed, and the variable arm motor 330 is driven so that the variable sub-arm 300 is shortened and then extended again, and thus the door 10 is finally disposed parallel to the vehicle body 1. At the instant time, in a state in which the opening of the door 10 is completed, the variable sub-arm 300 is extended to have the maximum length, and the main arm 200 is turned to the outside of the vehicle body 1 to the maximum.

The process of changing from a complete opening state to a complete closing state of the door 10 may be a reverse order of the process of FIG. 7, FIG. 8, FIG. 9 and FIG. 10.

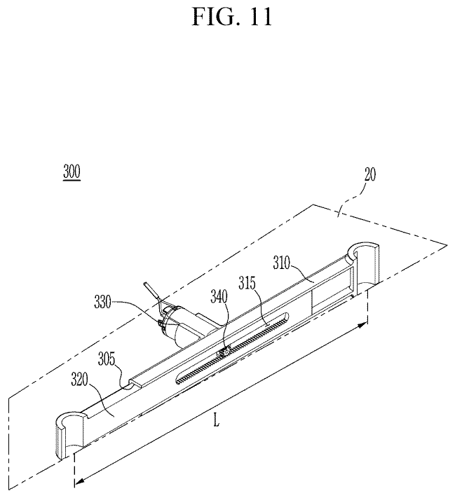

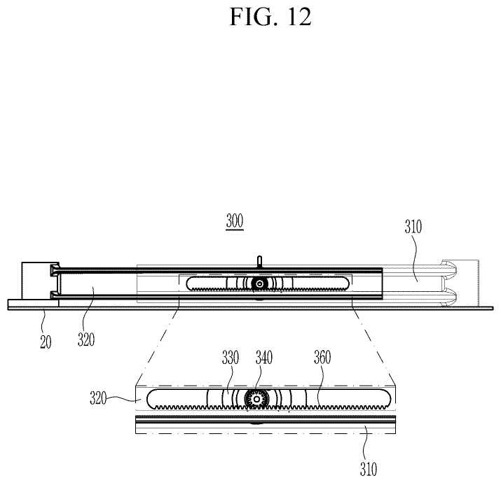

FIG. 11 is a perspective view schematically illustrating a variable sub-arm of the door open-close device for the vehicle according to an exemplary embodiment of the present disclosure. FIG. 12 is a diagram schematically illustrating a connection relationship between a pinion gear of a variable arm motor and a rack gear of a slide sub-arm for expanding or contracting a length of the variable sub-arm of the door open-close device for the vehicle according to an exemplary embodiment of the present disclosure.

Referring to FIG. 11 and FIG. 12, the variable sub-arm 300 includes the fixing sub-arm 310 in which a hollow is disposed and the slide sub-arm 320 slid and moved in the longitudinal direction of the fixing sub-arm 310 so that one end portion of the slide sub-arm 320 slides and moves relative to the fixing sub-arm 310.

The fixing sub-arm 310 may be disposed in a hollow shape extending in the longitudinal direction of the fixing sub-arm 310, and the slide sub-arm 320 may operate to be inserted into and withdrawn from the hollow of the fixing sub-arm 310.

The slide sub-arm 320 may be slid within the hollow of the fixing sub-arm 310 by driving the variable arm motor 330 disposed on one side of the fixing sub-arm 310.

An internal opening 315 is disposed in the slide sub-arm 320 in a longitudinal direction of the slide sub-arm 320, and a rack gear 360 is disposed inside the internal opening 315. Furthermore, a pinion gear 340 may be disposed on a rotation shaft of the variable arm motor 330, and may be engaged with the rack gear 360 of the slide sub-arm 320.

When the variable arm motor 330 is driven to rotate the rotation shaft, the pinion gear 340 is rotated, and the rack gear 360 engaged thereto is linearly moved, so that the slide sub-arm 320 may be slid and moved in the longitudinal direction of the fixing sub-arm 310, and the length of the variable sub-arm 300 may be expanded or contracted.

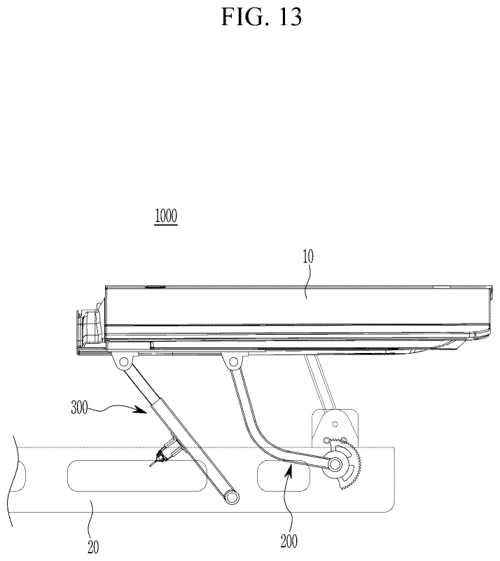

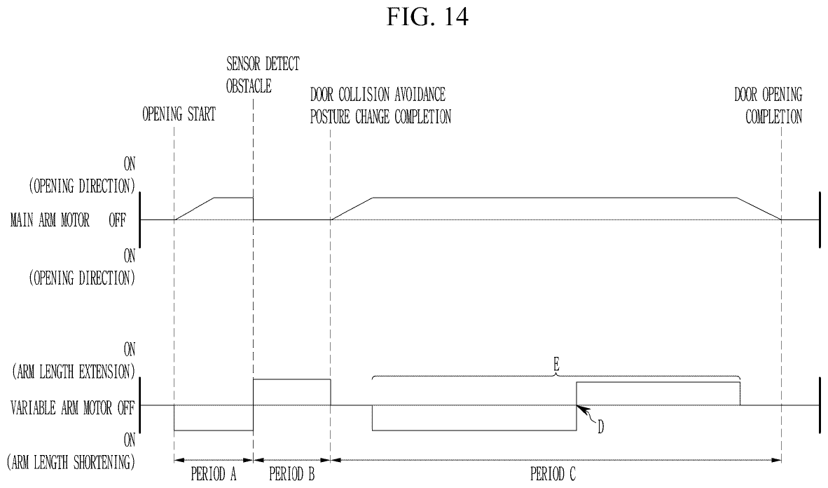

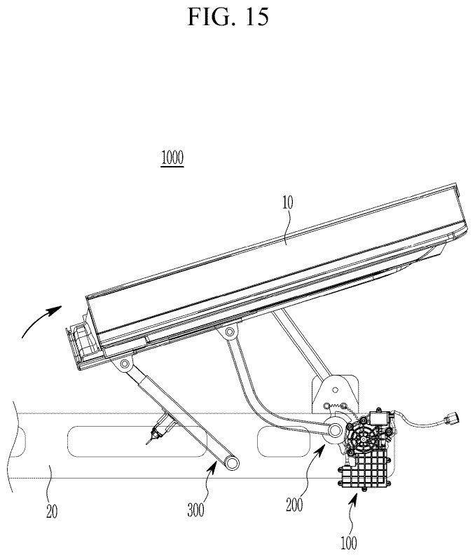

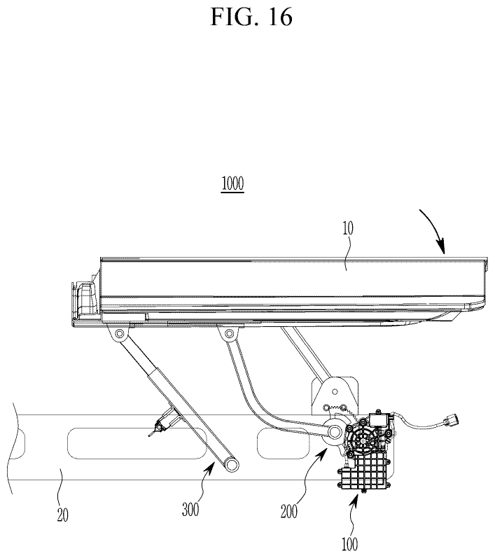

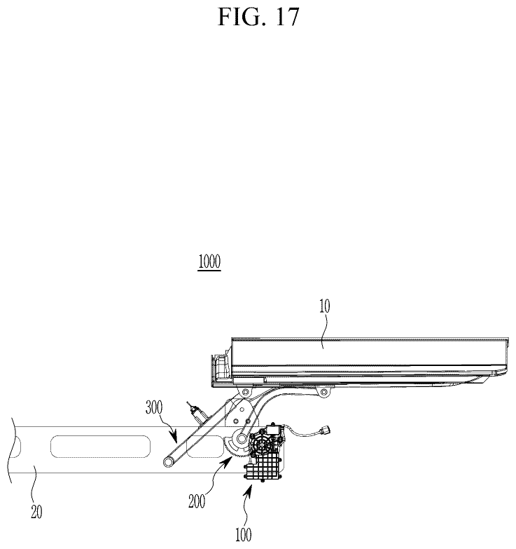

FIG. 13 is a diagram illustrating a connection relationship between the main arm and the variable sub-arm for adjusting a door angle and an amount of door protrusion when a door of the door open-close device for the vehicle according to an exemplary embodiment of the present disclosure is opened or closed. FIG. 14 is a graph illustrating driving states of a main arm motor and a variable arm motor for adjusting the door angle and the amount of door protrusion of the door open-close device for the vehicle according to an exemplary embodiment of the present disclosure. FIG. 15 is a diagram schematically illustrating a position, viewed from above, of the door of the door open-close device for the vehicle according to an exemplary embodiment of the present disclosure in a “period A” of FIG. 14. FIG. 16 is a diagram schematically illustrating a position, viewed from above, of the door of the door open-close device for the vehicle according to an exemplary embodiment of the present disclosure in a “period B” of FIG. 14. FIG. 17 is a diagram schematically illustrating a position, viewed from above, of the door of the door open-close device for the vehicle according to an exemplary embodiment of the present disclosure in a “period C” of FIG. 14.

As shown in FIG. 13, one end portion of the main arm 200 is hingedly coupled to the side of the vehicle body 1 and the other end portion thereof is hingedly coupled to the inside of the door 10. The variable sub-arm 300 is disposed in a position parallel to a longitudinal direction of the vehicle body 1, has one end portion hingedly coupled to the side of the vehicle body 1, and includes the other end portion hingedly coupled to the inside of the door 10. The main arm 200 may be disposed in a curved shape toward the interior of the vehicle body 1, and the variable sub-arm 300 may be disposed in a straight shape. The hinge rotation of the main arm 200 is performed by driving the main arm motor 100, and the hinge rotation of the variable sub-arm 300 is hingedly rotated together according to the hinge rotation of the main arm 200.

The variable sub-arm 300 includes the fixing sub-arm 310 and the slide sub-arm 320, and the slide sub-arm 320 may reciprocate inside the hollow of the fixing sub-arm 310 so that the variable sub-arm 300 may be expanded or contracted. The relative movement of the fixing sub-arm 310 and the slide sub-arm 320 may be performed by driving the variable arm motor 330 disposed on one side of the fixing sub-arm 310.

Referring to FIG. 14, and FIG. 15, when the door 10 starts to be opened in a state in which the driving of the main arm motor 100 and the variable arm motor 330 is stopped, the main arm motor 100 is driven and the main arm 200 starts to turn toward the outside of the vehicle body 1. At the instant time, the variable arm motor 330 is driven to shorten the length of the variable sub-arm 300. That is, the shaft of the variable arm motor 330 rotates, and the pinion gear 340 of the variable arm motor 330 is engaged with the rack gear 360 of the slide sub-arm 320 so that the slide sub-arm 320 is inserted and moved toward the hollow inside of the fixing sub-arm 310. As a result, the door 10 is disposed in an inclined form to protrude further from the side of the main arm 200 to the outside of the vehicle body 1 than from the side of the variable sub-arm 300.

Referring to FIGS. 14 and 16, when an obstacle is detected adjacent to the door 10 on the side of the main arm 200, the driving of the main arm motor 100 is stopped, and the variable arm motor 330 starts driving. The variable arm motor 330 is driven to extend the length of the variable sub-arm 300. The shaft of the variable arm motor 330 rotates so that the slide sub-arm 320 is moved to be withdrawn from the hollow inside of the fixing sub-arm 310. An amount of rotation of the variable arm motor 330 may be adjusted according to the position and size of the obstacle.

Referring to FIGS. 14 and 17, the main arm 200 is rotated by driving the main arm motor 100 until the opening of the door 10 is completed, and the variable arm motor 330 is driven so that the variable sub-arm 300 is shortened and then extends again, and thus the door 10 is finally disposed parallel to the vehicle body 1.

The shaft of the variable arm motor 330 is rotated so that the slide sub-arm 320 is inserted and moved toward the hollow inside of the fixing sub-arm 310, and thus the variable sub-arm 300 may be shortened. Thereafter, the shaft of the variable arm motor 330 rotates so that the slide sub-arm 320 is moved to be withdrawn from the hollow inside of the fixing sub-arm 310, and thus the variable sub-arm 300 is extended. When the opening of the door 10 is completed, the variable sub-arm 300 is extended to have the maximum length, and the main arm 200 is turned to the outside of the vehicle body 1 to the maximum. Furthermore, an opening width of the door 10 is also as large as possible.

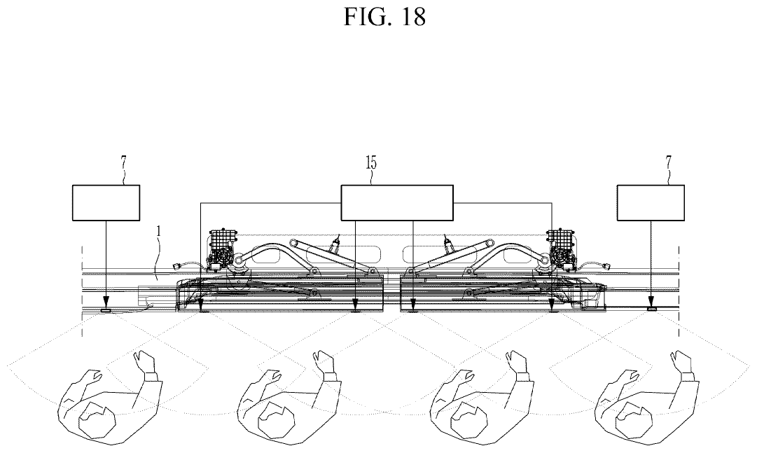

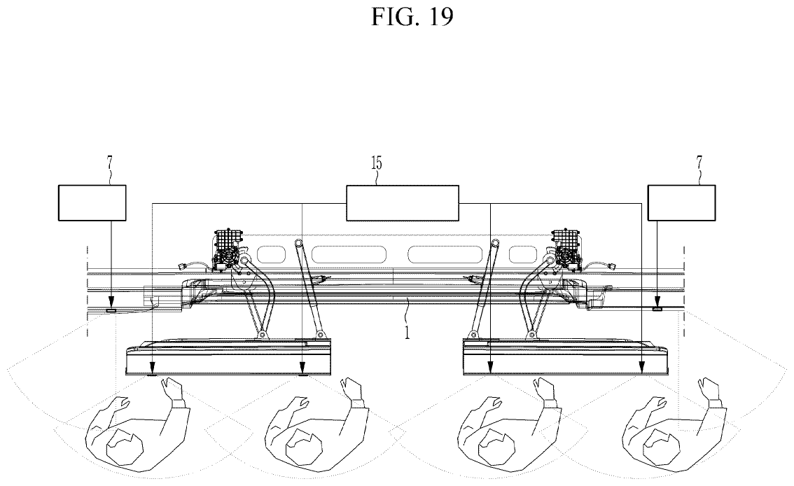

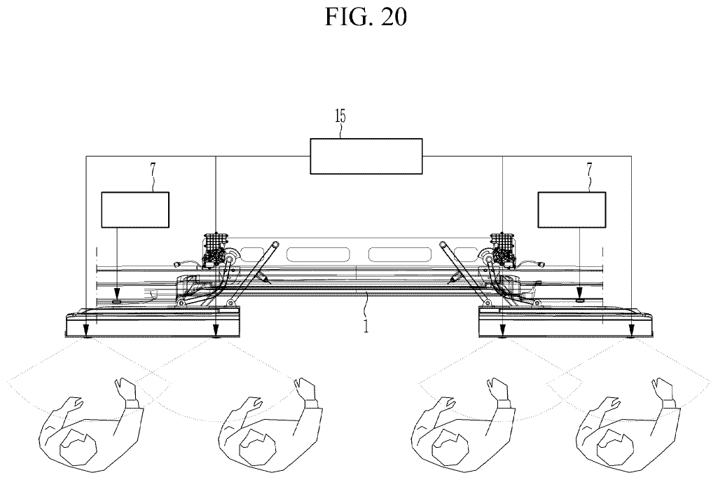

FIG. 18 is a diagram schematically illustrating a region, viewed from above, where an obstacle is detected by a door obstacle detection sensor and a vehicle body obstacle detection sensor in a door closing state of the door open-close device for the vehicle according to an exemplary embodiment of the present disclosure. FIG. 19 is a diagram schematically illustrating a region, viewed from above, where an obstacle is detected by the door obstacle detection sensor and the vehicle body obstacle detection sensor during door opening of the door open-close device for the vehicle according to an exemplary embodiment of the present disclosure. FIG. 20 is a diagram schematically illustrating a region, viewed from above, where an obstacle is detected by the door obstacle detection sensor and the vehicle body obstacle detection sensor when door opening of the door open-close device for the vehicle according to an exemplary embodiment of the present disclosure is completed.

As shown in FIGS. 18 to 20, the door obstacle detection sensor 15 detecting a proximity obstacle located outside the door 10 may be disposed on an external surface of the door 10, and the vehicle body obstacle detection sensor 7 detecting a proximity obstacle located outside the vehicle body 1 may be disposed on an external surface of the vehicle body 1.

The door obstacle detection sensor 15 may be disposed in a front and a rear of the door 10 in the longitudinal direction of the vehicle body 1, and the vehicle body obstacle detection sensor 7 may be disposed outside a door opening portion.

Each of the door obstacle detection sensor 15 and the vehicle body obstacle detection sensor 7 may be disposed as an ultrasonic sensor, and may include a detection range of an angle of about 135° to about 145° toward the outside of the vehicle body 1.

As shown in FIG. 18, in a state in which the door 10 is closed, each of the vehicle body obstacle detection sensor 7 and the door obstacle detection sensor 15 may detect obstacles in the entire detection range of an angle of about 135° to about 145° toward the outside of the vehicle body 1.

Furthermore, as shown in FIG. 19, in a state in which the door 10 is partially opened, the detection range of the vehicle body obstacle detection sensor 7 is limited, and as shown in FIG. 20, in a state in which the door 10 is completely opened, the vehicle body obstacle detection sensor 7 does not detect an obstacle, and the obstacle is detected only by the door obstacle detection sensor 15.

According to an exemplary embodiment of the present disclosure, the variable door arm structure is applied in the counter sliding door structure of the vehicle without a B-pillar, and thus, the door rotation radius may be minimized, minimizing the amount of protrusion toward the outside of the vehicle body of the door when the door is opened.

Furthermore, the interference avoidance operation between the front and rear doors is possible, which enables the door open-close operation regardless of the order of the front and rear doors, and sealing damage and jamming according to the order of door operations may be prevented.

Furthermore, the center rail structure is deleted, and thus, the door opening width may be maximized, and cost reduction, assembly, and maintainability may be improved due to the simplification of the structure.

Furthermore, the interaction between the variable door arm and the obstacle detection sensor may detect an external obstacle when the door operates and prevent the door from colliding with the obstacle.

Although exemplary embodiments of the present disclosure have been described above, the present disclosure is not limited to the above embodiments, the present disclosure includes all modifications within the range easily changed and recognized as being equivalent by those of ordinary skill in the art to which the present disclosure pertains from the exemplary embodiments of the present disclosure.

### DESCRIPTION OF SYMBOLS

1000: door open-close device
1: vehicle body
10: door
7: vehicle body obstacle detection sensor
15: door obstacle detection sensor
20: base plate
30: door bracket
100: main arm motor
110: main arm motor gear
200: main arm
210: main arm gear
300: variable sub-arm
310: fixing sub-arm
320: slide sub-arm
330: variable arm motor
340: pinion gear
350: variable arm motor mounting bracket
360: rack gear

What is claimed is:

1. A door open-close device configured to open or close a door opening portion of a vehicle by sliding and popping up a door disposed in a vehicle body, the door open-close device comprising:
a main arm motor fixedly disposed on a side of the vehicle body and configured to provide a driving power to operate the door;
a main arm including a first end portion engaged to the main arm motor and a second end portion hingedly coupled to a side of the door and configured to transmit a rotation force to the door by receiving the driving power from the main arm motor; and
a variable sub-arm including a first end portion hingedly coupled to the side of the vehicle body, and a second end portion hingedly coupled to the side of the door,
wherein the variable sub-arm is engaged to a gear connected to a variable arm motor and the variable sub-arm is disposed to change a length thereof due to operation of the gear driven by the variable arm motor for opening or closing the door.

2. The door open-close device of claim 1, further including:
a main arm gear disposed in the first end portion of the main arm;
a main arm motor gear disposed on a rotation shaft of the main arm motor and engaged with the main arm motor gear so that the main arm is hingedly rotated with respect to the first end portion of the main arm based on driving of the main arm motor.

3. The door open-close device of claim 1, wherein the main arm is disposed in a curved shape toward an interior of the vehicle body.

4. The door open-close device of claim 1, wherein the variable sub-arm comprises at least two sub-arms slidably engaged to each other.

5. The door open-close device of claim 3, wherein the at least two sub-arms of the variable sub-arm comprise:
a fixing sub-arm including a first end portion hingedly coupled to the side of the vehicle body and a hollow disposed in the fixing sub-arm; and
a slide sub-arm slidably engaged to the fixing sub-arm through the hollow and movable in a longitudinal direction of the fixing sub-arm so that a first end portion of the slide sub-arm engaged to the fixing sub-arm is movable relative to the fixing sub-arm, and a second end portion of the slide sub-arm is hingedly coupled to the side of the door.

6. The door open-close device of claim 5,
wherein the hollow of the fixing sub-arm is disposed to extend in the longitudinal direction, and
wherein the slide sub-arm is selectively inserted into or withdrawn from the hollow of the fixing sub-arm.

7. The door open-close device of claim 6, wherein the slide sub-arm slides based on the driving of the variable arm motor disposed on one side of the fixing sub-arm and is moved relative to the fixing sub-arm.

8. The door open-close device of claim 7,
wherein an internal opening is disposed in the slide sub-arm in a longitudinal direction of the slide sub-arm, and
wherein a rack gear is disposed on a side of the internal opening.

9. The door open-close device of claim 8, further comprising a pinion gear,
wherein the gear connected to the variable arm motor is the pinon gear, and
wherein the pinion gear is disposed on a rotation shaft of the variable arm motor, engaged with the rack gear of the slide sub-arm, and rotated by the variable arm motor, so that the slide sub-arm slides and moves along the fixing sub-arm in the longitudinal direction of the fixing sub-arm and thus a length of the variable sub-arm is expanded or contracted.

10. The door open-close device of claim 1, wherein a base plate in which the main arm motor is fixedly disposed and to which the first end portion of the main arm is hingedly coupled, and the first end portion of the variable sub-arm is hingedly coupled, is disposed on the side of the vehicle body.

11. The door open-close device of claim 10, wherein the variable arm motor is fixed on the fixing sub-arm by a variable arm motor mounting bracket.

12. The door open-close device of claim 1, wherein a door bracket to which a second end portion of the main arm and a second end portion of the variable sub-arm are hingedly coupled and which connects the main arm and the variable sub-arm to the door is disposed inside the door.

13. The door open-close device of claim 7, further comprising a door obstacle detection sensor disposed on an external surface of the door and configured to detect an obstacle located outside the door.

14. The door open-close device of claim 13, further comprising a vehicle body obstacle detection sensor disposed on an external surface of the vehicle body, wherein the vehicle body obstacle detection sensor is configured to detect an obstacle located outside the vehicle body.

15. The door open-close device of claim 14,
wherein the door obstacle detection sensor is disposed in front and rear of the door in the longitudinal direction of the vehicle body, and
wherein the vehicle body obstacle detection sensor is disposed outside the door opening portion.

16. The door open-close device of claim 15, wherein each of the door obstacle detection sensor and the vehicle body obstacle detection sensor includes an ultrasonic sensor, and has a detection range of an angle of about 135° to about 145° toward outside the vehicle body.

17. The door open-close device of claim 16, wherein based on that the door starts to be opened, the main arm motor is driven to rotate the first end portion of the main arm, and the variable arm motor is driven to shorten the length of the variable sub-arm.

18. The door open-close device of claim 17, wherein
during the opening of the door, based on that the obstacle is detected by the door obstacle detection sensor or the vehicle body obstacle detection sensor,
driving of the main arm motor is stopped, and the variable arm motor is driven to extend the length of the variable sub-arm so that a position of the door is changed to an obstacle avoidance position.

19. The door open-close device of claim 18, wherein
after the position of the door is changed to the obstacle avoidance position,
the main arm motor is driven again to rotate the first end portion of the main arm, and
the variable arm motor is driven to shorten the length of the variable sub-arm again after the driving of the variable arm motor is stopped for a predetermined time period, and is driven to extend the length of the variable sub-arm again based on that an amount of protrusion of the door is maximum.

20. A vehicle comprising the door open-close device of claim 1.
